(19) United States
(12) Patent Application Publication
(10) Pub. No.: US 2024/0230485 A1
(43) Pub. Date: Jul. 11, 2024

(54) USE OF METHYLENE BLUE AND FLUORESCEIN SODIUM DOUBLE-STAINING IN LIVE CELL IMAGING

(71) Applicant: Huimin ZHANG, Shanghai (CN)

(72) Inventor: Huimin ZHANG, Shanghai (CN)

(21) Appl. No.: 18/558,308

(22) PCT Filed: Jun. 1, 2021
(86) PCT No.: PCT/CN2021/097584

§ 371 Date: Oct. 31, 2023

(51) Int. Cl. G01N 1/30; G01N 21/64

(52) U.S. Cl. CPC G01N 1/30; G01N 21/6428; G01N 21/6458; G01N 2001/302; G01N 2021/6441

(57) ABSTRACT

A fluorescent staining method for live cell imaging. The method includes: performing double-staining on cells by means of using fluorescein sodium and methylene blue, and using a fluorescence microscope to detect and display a clear fluorescent cell image.

### CROSS REFERENCE TO RELATED APPLICATION

This application claims the priority benefit of PCT international application No. PCT/CN2021/097584, filed on Jun. 1, 2021, and entitled “USE OF METHYLENE BLUE AND FLUORESCEIN SODIUM DOUBLE-STAINING IN LIVE CELL IMAGING”, wherein the content of said application is hereby incorporated by reference in its entireties.

### TECHNICAL FIELD

The present disclosure relates to a method for cell staining, in particular to a method of double-staining by fluorescent biological markers, belonging to the field of biotechnology.

### BACKGROUND

Fluorescence staining in combination with fluorescence microscopy has made fluorescence imaging widely used in the detection of bioactive substances and cell imaging. Cell imaging is important research means in the field of life science technology. Fluorescent staining has advantages such as high sensitivity, high selectivity, simple operation, sensitive reaction etc., as compared with other technologies, and is currently a highly sensitive visual analysis technology widely used in living cell analysis.

Fluorescence is a cold luminescence phenomenon of “photoluminescence”. A substance at room temperature, when irradiated by incident light with a specific wavelength, absorbs light energy and enters an excited state, immediately emitting an emergent light having a wavelength longer than that of the incident light, which is called fluorescence.

There are two types of fluorescence spectrum, including excitation spectrum and emission spectrum. The excitation spectrum refers to the relationship between the intensity or luminescent efficiency of a luminescent spectral line and band of a fluorescent substance and the wavelength of the excitation light under the excitation of the substance by light with different wavelengths. The emission spectrum refers to the varied luminous intensity of the excitation light having different wavelengths of the fluorescent substance under the excitation by an excitation light. Every fluorescent substance has excitation and emission spectra, as well as its excitation and emission bands. Current studies on fluorescence mainly focus on the excitation and emission spectra of fluorescent substances, such as 5-aminolevulinic acid (5-ALA), which is widely used in clinics, in order to find their excitation and emission bands.

Fluorescence detection of malignant lesions based on 5-ALA is currently used in brain surgery, urology surgery, and gastrointestinal surgery. 5-ALA-induced protoporphyrin IX (PPIX) fluorescence detection has recently become a promising method for detecting malignant lesions during operation. In order to improve the accuracy of 5-ALA fluorescence detection under strong spontaneous fluorescence conditions, several spectral analysis methods have been developed (Valdes, P. A. et al. (2011) Neurosurg. 115, 11-17; Xu, H.& Rice, B. W. (2009) Journal of biomedical optics 14, 064011; Harada, K. et al. (2013) International Journal of Molecular Sciences 14, 23140-23152; Koizumi, N. et al. (2013) Ann. Surg. Oncol. 20, 3541-3548; Kondo, Y et al. (2014) Int. J. Oncol. 45, 41-46). Although some studies have reported the effectiveness of 5-ALA fluorescence detection methods in clinical applications, detection errors often occur due to the strong fluorescent background of chromophores themselves.

### SUMMARY

A main object of the present disclosure is to provide a novel staining method that utilizes fluorescent biomarkers to double-stain living cells.

The present disclosure provides the following technical solution.

The present disclosure provides a method for staining living cells, including: simultaneously or separately, (i) staining target cells with a first fluorescent biomarker; (ii) staining said target cells with a second fluorescent biomarker; and (iii) obtaining a fluorescence image of said target cell under a fluorescence microscope. The method allows observing the morphology of the cells while observing the morphology of cell nucleus.

In an embodiment, the first fluorescent biomarker has an excitation wavelength of 460 to 800 nm.

In an embodiment, the second fluorescent biomarker has an excitation wavelength of 350 to 670 nm.

In an embodiment, a maximum value of an emission spectrum of the second fluorescent biomarker differs by at least 50 nm from a maximum value of an emission spectrum of the first fluorescent biomarker.

In an embodiment, the first fluorescent biomarker emits light while the second fluorescent biomarker absorbs light during obtaining the fluorescence image of said target cell under the fluorescence microscope.

In an embodiment, the first fluorescent biomarker is selected from the group consisting of sodium fluorescein, 5-aminolevulinic acid, and indocyanine green.

In an embodiment, the second fluorescent biomarker mentioned above is selected from the group consisting of methylene blue, acridine yellow, and crystal violet.

In an embodiment, the first fluorescent biomarker is sodium fluorescein, and the second fluorescent biomarker is methylene blue.

In an embodiment, the sodium fluorescein has a concentration of 0.1% to 1%, and the methylene blue has a concentration of 0.5% to 3%.

In an embodiment, the sodium fluorescein has a concentration of 0.25%, and the methylene blue has a concentration of 1%.

In an embodiment, the first fluorescent biomarker mentioned above is 5-aminolevulinic acid, and the second fluorescent biomarker is acridine yellow.

In an embodiment, 5-aminolevulinic acid has a concentration of 0.05%, and acridine yellow has a concentration of 1%.

In an embodiment, the first fluorescent biomarker is indocyanine green, and the second fluorescent biomarker is crystal violet.

In an embodiment, indocyanine green has a concentration of 0.05%, and crystal violet has a concentration of 0.05%.

In an embodiment, the method is for staining living tissues.

In an embodiment, the living cells referred to in the present disclosure include cancer cells.

In an embodiment, the first fluorescent biomarker and the second fluorescent biomarker are administrated to an affected area before performing surgical procedures.

In an embodiment, the surgical procedures are cancer surgical procedures.

In another embodiment, the present disclosure also provides a composition for staining living cells, including a first fluorescent biomarker and a second fluorescent biomarker.

In an embodiment, the second fluorescent biomarker mentioned above is selected from the group consisting of methylene blue, acridine yellow, and crystal violet.

In an embodiment, the first fluorescent biomarker is sodium fluorescein, and the second fluorescent biomarker is methylene blue.

In an embodiment, the sodium fluorescein has a concentration of 0.1% to 1%, and the methylene blue has a concentration of 0.5% to 3%.

In an embodiment, the sodium fluorescein has a concentration of 0.25%, and the methylene blue has a concentration of 1%.

In an embodiment, the first fluorescent biomarker is 5-aminolevulinic acid, and the second fluorescent biomarker is acridine yellow.

In an embodiment, 5-aminolevulinic acid has a concentration of 0.05%, and acridine yellow has a concentration of 1%.

In an embodiment, the first fluorescent biomarker is indocyanine green, and the second fluorescent biomarker is crystal violet.

In an embodiment, indocyanine green has a concentration of 0.05%, and crystal violet has a concentration of 0.05%.

In an embodiment, the composition also includes stabilizers, antioxidants, protectants, preservatives, and pH regulators.

The composition of the present disclosure is also formulated with one or more physiologically acceptable carriers including excipients and auxiliaries that facilitate the processing of the active agent into a pharmaceutically acceptable formulation. The formulation depends on the route of administration selected.

The stabilizer can be one or more selected from the group consisting of sorbitol ester, polyoxyethylene hydrogenated castor oil, and polyvinyl alcohol.

The antioxidant can be one or more selected from the group consisting of sodium sulfite, potassium sulfite, sodium sulfate, potassium sulfate, citric acid, dibutyl hydroxytoluene, tert-butyl hydroquinone, and citric acid.

The protective agent can be one or more selected from the group consisting of hydroxypropyl methylcellulose, sodium hyaluronate for medical use, polyacrylamide, carbomer, xylitol, glucose, and alkyl glucoside.

The pH regulator can be one or more selected from the group consisting of sodium dihydrogen phosphate, disodium hydrogen phosphate, potassium dihydrogen phosphate, dipotassium hydrogen phosphate, boric acid, borax, acetic acid, sodium acetate, citric acid, sodium citrate, tartaric acid, sodium tartrate, sodium carbonate, potassium carbonate, sodium bicarbonate, sodium hydroxide, potassium hydroxide, triethanolamine, hydrochloric acid, and phosphoric acid.

The preservative can be one or more selected from the group consisting of benzalkonium chloride, benzalkonium bromide, chlorobutanol, and sorbitol.

The aforementioned composition of the present disclosure may have other alternative names during actual sales, such as reagent kits, kits, sets, or systems. Two substances in the aforementioned composition can be mixed and packaged together, or packaged separately.

In an embodiment of the present disclosure, two dyes with different fluorescence wavelengths are examples for illustration. It should be understood that tissues can be stained with a combination of three or more different dyes, as long as they recognize targets that are different from each other and they have different fluorescence wavelengths.

Further, the fluorescent biomarker may also be dyes selected from the group consisting of fluorescein isothiocyanate (FITC), phycoerythrin, phycocyanin, allophycocyanin, ophthaldehyde, rhodamine, and AlexaFluor series dyes, DAPI, Hoechst33342 thiazole orange, acridine orange, and the like.

In practical application, the staining method of the present disclosure can be applied not only to pathological tissue sections, but also to staining of living tissues and in vitro cultured cells. Cells of the tissue to be imaged, cells on microcarriers, or cells on smears can be directly contacted and stained with the dye of the present disclosure. So it can be further applied for clinical use such as surgical procedures, diagnosis, drug delivery, and the like.

### BRIEF DESCRIPTION OF THE ACCOMPANY DRAWINGS

FIG. 1: Comparison of the imaging effects of methylene blue alone, sodium fluorescein alone, and methylene blue-sodium fluorescein double staining in mouse kidneys. FIG. 1A shows the imaging results of staining with sodium fluorescein alone at a wavelength of 470 nm. FIG. 1B shows the imaging results of staining with methylene blue alone at a wavelength of 470 nm. FIG. 1C shows the imaging results of staining with methylene blue alone at a wavelength of 660 nm. FIG. 1D shows the imaging results of double-staining with sodium fluorescein and methylene blue at a wavelength of 470 nm. FIG. 1E shows the HE staining control.

FIG. 2: Comparison of the imaging effects of methylene blue alone, sodium fluorescein alone, and methylene blue-sodium fluorescein double staining in mouse livers. FIG. 2A shows the imaging results of staining with sodium fluorescein alone at a wavelength of 470 nm. FIG. 2B shows the imaging results of staining with methylene blue alone at a wavelength of 470 nm. FIG. 2C shows the imaging results of double-staining with sodium fluorescein and methylene blue at a wavelength of 470 nm. FIG. 2D shows the HE staining control.

FIG. 3: Comparison of the imaging effects of double-staining with methylene blue and sodium fluorescein at different concentrations in pig kidneys. FIG. 3A shows the imaging results of staining with 0.1% sodium fluorescein in combination with 0.5% methylene blue at a wavelength of 470 nm. FIG. 3B shows the imaging results of staining with 0.25% sodium fluorescein in combination with 1% methylene blue at a wavelength of 470 nm. FIG. 3C shows the imaging results of staining with 0.5% sodium fluorescein in combination with 2% methylene blue at a wavelength of 470 nm. FIG. 3D shows the imaging results of staining with 1% sodium fluorescein in combination with 3% methylene blue at a wavelength of 470 nm.

FIG. 4: Imaging results of double-staining with 5-ALA and acridine yellow in pig livers.

FIG. 5: Imaging results of double-staining with methylene blue and ICG in pig livers.

FIG. 6: Imaging results of double-staining with sodium fluorescein and crystal violet in pig kidneys.

### DETAILED DESCRIPTION

Some fluorescent biomarkers have been studied. In addition to the aforementioned 5-ALA, sodium fluorescein (FS) and indocyanine green (ICG) are currently widely used.

Sodium fluorescein is a fluorescent dye for living bodies, and its aqueous solution can label cell body contours, and are used to improve the visualization of tumor tissue. Fluorescein has no specificity for tumor cells. This dye, when excited by light with a wavelength ranging from 460 to 500 nm, emits fluorescent radiation with a wavelength ranging from 540 to 690 nm, rendering wide applications in medicine, especially in brain tumor surgery (Copeman S M, Coke F, Gouldesbrough C., Br Med J. (1929) 2:233-42; Hamamcioglu M K. et al., Clin Neurol Neurosurg (2016) 143:39-45; O'goshi K, Serup J., Ski Res Technol. (2006) 12:155-61; Koc K. et al., Br J Neurosurg (2008) 22:99-103; Hara T. et al., Am J Ophthalmol. (1998) 126:560-4; Kuroiwa T. et al., Surg Neurol (1998) 50:41-8).

Indoline Green (ICG) is an amphipathic small molecule (<800 Daltons) that is a near-infrared (NIR) fluorophore (peak excitation=805 nm, peak emission=835 nm). Indoline Green usually remains in blood vessels when injected intravenously, and mainly binds to albumin and other plasma proteins, which enables near-infrared imaging to depict the vascular system. In recent years, It is found from the study of tumor tissues in rats and human patients, ICG is accumulated in tumors with a striking contrast between tumor and background. ICG has been proven to be useful in labeling tumor tissue (Cho S S. et al., (2019) Front. Surg. 6:11; Hansen D A et al., Surg Neurol. (1993) 40:451-6; Haglund M M. et al., Neurosurgery. (1994) 35:930-40; Haglund M M., et al., Neurosurgery. (1996) 38:308-17; Madajewski B., et al., Clin Cancer Res. (2012) 18:5741-51; 30. Jiang J X., et al., Am J Nucl Med Mol Imaging. (2015) 5:390-400; Zeh R. et al., PLoS ONE. (2017) 12: e0182034).

Methylene blue (MB), also known as Basic Blue 9, is a nontoxic alternative dye approved by the US Food and Drug Administration for the treatment of methemoglobinemia. Meilan is another near-infrared fluorophore that is currently available in human clinical trials in addition to ICG. It has peak emission at 700 nm and emits fluorescence in different near-infrared bands compared to sodium fluorescein and ICG.

Although the current research and application of fluorescent dyes are very extensive, there are still shortcomings in the staining effects of these fluorescent dyes. For example, sodium fluorescein and ICG do not have specificity. 5ALA has higher specificity than that of sodium fluorescein, but poor sensitivity and contrast with the surrounding normal tissue (Okuda T. et al., J Clin Neurosci. (2012) 19:1719-22; Acerbi F. et al., Neurosurg. Focus. (2014) 36:E5; Okuda T. et al., J Clin Neurosci. (2010) 17:118-121; 35. Chen B. et al., Int J Med Sci. (2012) 9:708-714; Francaviglia N. et al., Surg Neurol Int. (2017) 8:145; Bowden S G. et al., Neurosurgery. (2018) 82:719-27). Some studies have attempted dual injections of 5-ALA and fluorescein to enhance the detection of tumor tissue by increasing the comparison between tumor tissue uptaking 5-ALA and the peritumoral area uptaking fluorescein (SueroMolina E. et al., J Neurosurg. (2018) 128:399-405), with improved results, but still insufficient to meet clinical needs.

The wide applications of fluorescent dyes in clinical practice are described above, showing the cases in which fluorescence imaging is formed to facilitate the observation of overall tissues through the absorption and conversion of the dyes by cell masses, combined with the cold luminescence phenomenon of “photoluminescence” of fluorescence. However, when observing living cells by fluorescence microscopy, these dyes, when absorbed by a single cell, can only be absorbed by the cell body or the cell nucleus. Thus, when living cells are fluorescence stained and observed under a fluorescence microscope, acridine yellow staining imaging can show cell nucleus morphology, but not cell morphology, and sodium fluorescein staining imaging can show cell morphology, but not cell nucleus morphology. Only the morphology of the nucleus or cell can be observed microscopically, which does not meet the need to observe the morphology of the nucleus or cell both during cell observation.

To sum up, the common fluorescence staining methods currently used for living cell imaging analysis have drawbacks in practical applications, such as the requirement of fixing cells, cumbersome operation, long staining time, no specificity, insufficient contrast, and inability to clearly observe both cell and nuclear morphology.

The present disclosure provides a method for staining living cells, including: simultaneously or separately, (i) staining target cells with a first fluorescent biomarker; (ii) staining said target cells with a second fluorescent biomarker; and (iii) obtaining a fluorescence image of said target cell under a fluorescence microscope. The method allows observing the morphology of the cells while observing the morphology of cell nucleus.

The present inventor found that the method of sodium fluorescein and methylene blue double-staining can significantly improve the imaging effect. Sodium fluorescein, which improves the contrast against the background, and methylene blue, which well labels the cell nucleus, make it possible to observe the morphology of the cells while clearly observing the cell nucleus, especially get important information, such as changes in the nucleus-to-cytoplasm ratio of tumor cells, so as to clearly distinguish normal tissues from tumor tissues and visualize the boundary between tumor and non-tumor tissues, thereby meeting the clinical needs. In addition, both dyes have been approved for clinical use currently, ensuring their safety.

Compared with the related art, the present disclosure has the following advantages.

The present disclosure provides a method of double-staining by fluorescent biomarkers for live cell imaging, which has advantages of rapidness, high efficiency, safety, and so on. It allows for observing the morphology of the cells while observing the morphology of the cell nucleus and for distinguishing normal cells from tumor cells clearly. It is of great significance to the development of the fields such as tissue staining, cell morphology research, image-guided surgery, and the like.

The present disclosure is further described in conjunction with the accompanying drawings and specific embodiments and is not limited to the following embodiments. It should also be understood that the terms used in the embodiments of the present disclosure are intended to describe specific embodiments, rather than to limit the scope of protection of the present disclosure. Without departing from the spirit and scope of the inventive concept, variations and advantages that will occur to those skilled in the art are included in the present disclosure, and the protection scope of the present disclosure is based on the accompanying claims and any equivalents. In the specification and claims of the present disclosure, singular forms “a”, “an”, and “the” include plural forms unless the context clearly indicates otherwise. The methods of experimentation in the following Examples that do not specify specific conditions are general knowledge and common knowledge of those skilled in the art, or are based on the conditions recommended by the manufacturer. Unless otherwise specified, all materials and reagents used in the Examples are commercially available.

### Mice

Mice are C57BL6 strains purchased from Animal Center, Nanjing University.

### Fluorescence Image Analysis

Fluorescence images were obtained under MCI microscope (DiveScope). The samples were stained and observed at a wavelength of 470 nm, and regions of interest were randomly selected for imaging.

### Preparation of Staining Solution

0.1% sodium fluorescein: 0.01 g of sodium fluorescein powder was weighed and added into a light-proof tube, followed by adding 10 mL of normal saline. The tube was shaken well, wrapped with tin foil, and stored in the dark.

0.25% sodium fluorescein: 0.025 g of sodium fluorescein powder was weighed and added into a light-proof tube, followed by adding 10 mL of saline cleaning solution. The tube was shaken well, wrapped with tin foil, and stored in the dark.

0.5% sodium fluorescein: 0.05 g of sodium fluorescein powder was weighed and added into a light-proof tube, followed by adding 10 mL of normal saline. The tube was shaken well, wrapped with tin foil, and stored in the dark.

1% sodium fluorescein: 0.1 g of sodium fluorescein powder was weighed and added into a light-proof tube, followed by adding 10 mL of normal saline. The tube was shaken well, wrapped with tin foil, and stored in the dark.

0.5% Methylene Blue: 0.05 g of methylene blue powder was weighed and added into a light-proof tube, followed by adding 10 mL of 5% sodium bicarbonate solution. The tube was shaken well, wrapped with tin foil, and stored in the dark.

1% Methylene Blue: 0.1 g of methylene blue powder was weighed and added into a light-proof tube, followed by adding 10 mL of 5% sodium bicarbonate solution. The tube was shaken well, wrapped with tin foil, and stored in the dark.

2% Methylene Blue: 0.2 g of methylene blue powder was weighed and added into a light-proof tube, followed by adding 10 mL of 5% sodium bicarbonate solution. The tube was shaken well, wrapped with tin foil, and stored in the dark.

3% Methylene Blue: 0.3 g of methylene blue powder was weighed and added into a light-proof tube, followed by adding 10 mL of 5% sodium bicarbonate solution. The tube was shaken well, wrapped with tin foil, and stored in the dark.

0.05% 5-ALA (5-aminolevulinic acid): 0.005 g of 5-ALA powder was weighed and added into a light-proof tube, followed by adding 10 mL of 5% glucose solution. The tube was shaken well, wrapped with tin foil, and stored in the dark.

1% acriflavine: 0.1 g of acriflavine powder was weighed and added into a light-proof tube, followed by adding 10 mL of normal saline. The tube was shaken well, wrapped with tin foil, and stored in the dark.

0.05% ICG (indocyanine-green): 0.005 g of ICG powder was weighed and added into a light-proof tube, followed by adding 10 mL of normal saline. The tube was shaken well, wrapped with tin foil, and stored in the dark.

0.05% crystal violet: 0.005 g of crystal violet powder was weighed and added into a light-proof tube, followed by adding 10 mL of normal saline. The tube was shaken well, wrapped with tin foil, and stored in the dark.

### Example 1. Tissue Staining by Double-Staining with Sodium Fluorescein and Methylene Blue

1.1 Staining in Mouse Kidneys

Mouse tissues were stained as follows:
1. Mice were anesthetized by abdominal injection with 1% sodium pentobarbital at an anesthetic dose of 8 to 9 mL/g.
2. After removing the dorsal hair of the mouse, the skin was cut with scissors to expose the kidney, which was then completely excised and taken out. With the kidney surface fixed with a blade, the renal capsule on the surface of the kidney was removed using scissors and forceps.
3. After bleeding was stopped with cotton swabs, the kidney surface was applied with 0.25% sodium fluorescein for staining for 2 minutes, and washed three times with normal saline. Then, the kidney surface was applied with 1% methylene blue staining solution for staining for 2 minutes, and washed three times with normal saline before observation under a microscope at a wavelength of 470 nm.

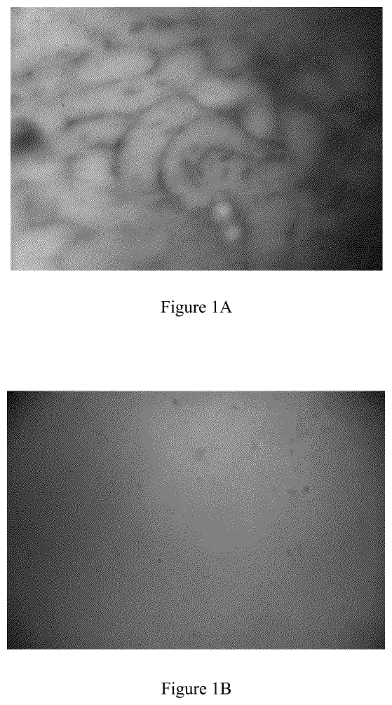

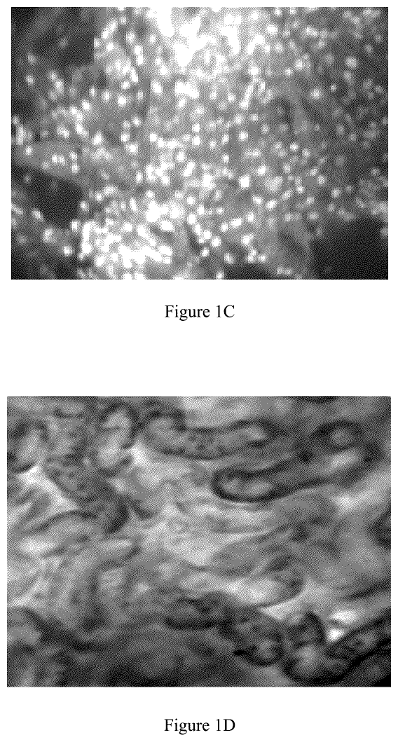

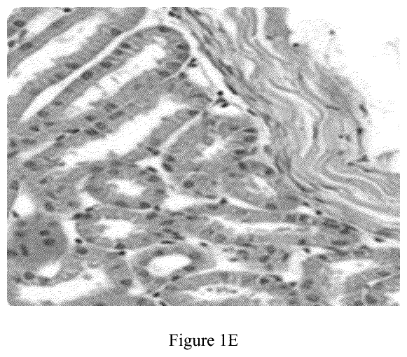

Results in FIG. 1 show the comparison of the imaging effects of staining with methylene blue alone, staining with sodium fluorescein alone, and methylene blue-sodium fluorescein double staining in mouse kidneys. FIG. 1A shows the imaging results of staining with sodium fluorescein alone at a wavelength of 470 nm. FIG. 1B shows the imaging results of staining with methylene blue alone at a wavelength of 470 nm. It can be seen that it was unable to be imaged with methylene blue at a wavelength of 470 nm. FIG. 1C shows the imaging results of staining with methylene blue alone at a wavelength of 660 nm. FIG. 1D shows the imaging results of double-staining with sodium fluorescein and methylene blue at a wavelength of 470 nm. The contours of the mouse renal tubular cells and the morphology of the cell nuclei can be clearly seen after double-staining with sodium fluorescein and methylene blue. FIG. 1E shows the HE staining control.

### 1.2 Staining in Mouse Livers

Mouse tissues were stained as follows:
1. Mice were anesthetized by abdominal injection with 1% sodium pentobarbital at an anesthetic dose of 8 to 9 mL/g.
2. After removing the abdominal hair of the mouse, the skin was cut with scissors to expose the liver, which was then completely excised and taken out. The liver surface was fixed with a blade.
3. The liver surface was applied with 0.25% sodium fluorescein for staining for 2 minutes, and washed three times with normal saline. Then, the liver surface was applied with 1% methylene blue staining solution for staining for 2 minutes, and washed three times with normal saline before observation under a microscope at a wavelength of 470 nm.

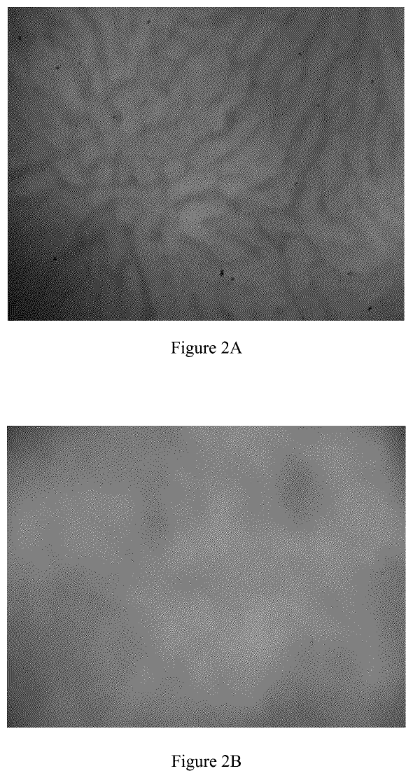

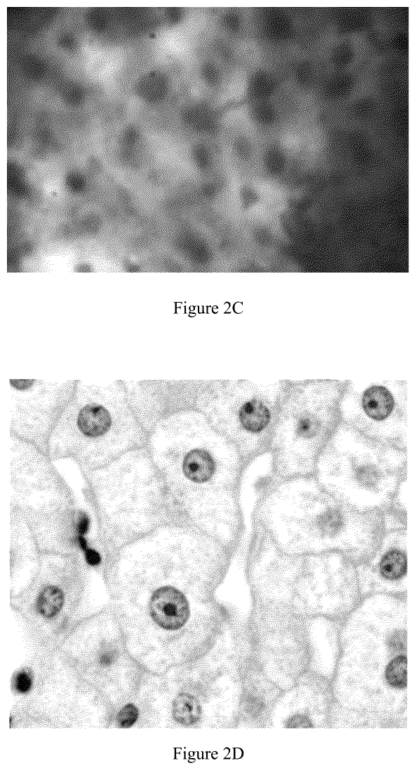

FIG. 2 shows the comparison of the imaging effects of staining with methylene blue alone, sodium fluorescein alone, and methylene blue-sodium fluorescein double staining in mouse livers. FIG. 2A shows the imaging results of staining with sodium fluorescein alone at a wavelength of 470 nm. FIG. 2B shows the imaging results of staining with methylene blue alone at a wavelength of 470 nm. It can be seen that it was unable to be imaged with methylene blue at a wavelength of 470 nm. FIG. 2C shows the imaging results of double-staining with sodium fluorescein and methylene blue at a wavelength of 470 nm. The contours of the mouse liver cells and the morphology of the cell nuclei can be clearly seen after double-staining with sodium fluorescein and methylene blue. FIG. 1E shows the HE staining control.

From FIGS. 1 and 2, it can be observed that the imaging effect of double staining with sodium fluorescein and methylene blue is significantly improved compared to that of staining with sodium fluorescein or methylene blue alone. Double staining with sodium fluorescein and methylene blue improves the contrast against the background and makes it possible to clearly observe tissue and cell morphology while clearly observing the cell nucleus, even the cell nucleolus. This information will help doctors determine tumor and non-tumor tissues, and is of great value to medical treatment.

### Example 2. Effects of Double-Staining with Methylene Blue and Sodium Fluorescein at Different Concentrations

Pig kidneys as tissues were stained as follows:
1. Several fresh pig kidneys were purchased and refrigerated at 4° C. for later use.
2. The fresh pig kidneys were cleaned with clean water, and the renal capsule on the surface of the kidney was removed using scissors and forceps.
3. The kidney surface was applied with 0.1%, 0.25%, 0.5%, or 1% sodium fluorescein respectively for 1 minute, and washed three times with normal saline. Then, the kidney surface was applied with 0.5%, 1%, 2%, or 3% methylene blue staining solution for 1 minute, respectively, and washed three times with normal saline before observation under a microscope at a wavelength of 470 nm.

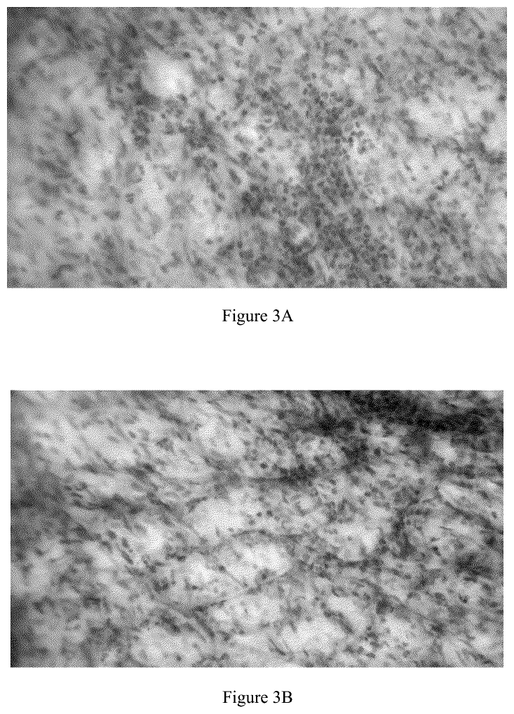

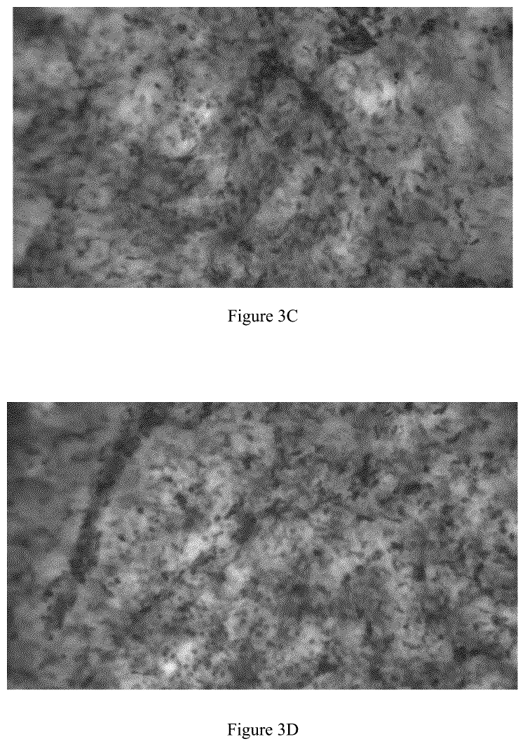

FIG. 3 shows the comparison of the imaging effects of double-staining with methylene blue in combination with sodium fluorescein at different concentrations in pig kidneys. FIG. 3A shows the imaging results of staining with 0.1% sodium fluorescein in combination with 0.5% methylene blue at a wavelength of 470 nm. FIG. 3B shows the imaging results of staining with 0.25% sodium fluorescein in combination with 1% methylene blue at a wavelength of 470 nm. FIG. 3C shows the imaging results of staining with 0.5% sodium fluorescein in combination with 2% methylene blue at a wavelength of 470 nm. FIG. 3D shows the imaging results of staining with 1% sodium fluorescein in combination with 3% methylene blue at a wavelength of 470 nm.

From FIG. 3, it can be observed that the combinations of sodium fluorescein and methylene blue at different concentrations with sodium fluorescein concentrations ranging from 0.1% to 1% and methylene blue concentrations ranging from 0.5% to 3% have similar staining effects and allow clear identification of the cell morphology and the cell nuclear structure.

### Example 3. Tissue Staining by Double-Staining with 5-ALA and Acridine Yellow

Pig livers as tissues were stained as follows:
1. Several fresh pig livers were purchased and refrigerated at 4° C. for later use.
2. The fresh pig livers were cleaned with clean water, and the renal capsule on the surface of the liver was removed using scissors and forceps.
3. The liver surface was applied on with 0.05% 5-ALA for staining for 3 minutes, and washed three times with normal saline. Then, the liver surface was applied with 1% acridine yellow staining solution for staining for 2 minutes, and washed three times with normal saline before observation under a microscope at a wavelength of 635 nm.

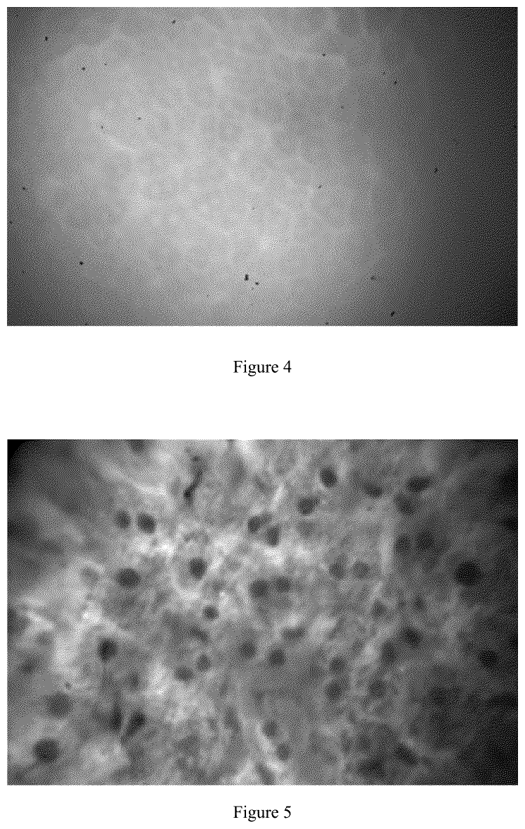

FIG. 4 shows the imaging results of double-staining with 5-ALA and acridine yellow in pig livers. The contours of the liver cells and the morphology of the cell nuclei can be clearly seen after staining.

### Example 4. Tissue Staining by Double-Staining with Methylene Blue and ICG

Pig livers as tissues were stained as follows:
1. Several fresh pig livers were purchased and refrigerated at 4° C. for later use.
2. The fresh pig livers were cleaned with clean water, and the renal capsule on the surface of the liver was removed using scissors and forceps.
3. The liver surface was applied with 1% methylene blue for staining for 2 minutes, and washed three times with normal saline. Then, the liver surface was applied with 0.05% ICG staining solution for staining for 2 minutes, and washed three times with normal saline before observation under a microscope at a wavelength of 835 nm.

FIG. 5 shows the imaging results of double-staining with methylene blue and ICG in pig kidneys. The contours of the liver cells and the morphology of the cell nuclei can be clearly seen after staining.

### Example 5. Tissue Staining by Double-Staining with Sodium Fluorescein and Crystal Violet

Pig kidneys as tissues were stained as follows:
1. Several fresh pig kidneys were purchased and refrigerated at 4° C. for later use.
2. The fresh pig kidneys were cleaned with clean water, and the renal capsule on the surface of the kidney was removed using scissors and forceps.
3. The kidney surface was applied with 0.25% sodium fluorescein for staining for 2 minutes, and washed three times with normal saline. Then, The kidney surface was applied with 0.05% crystal violet staining solution for staining for 3 minutes, and washed three times with normal saline before observation under a microscope at a wavelength of 525 nm.

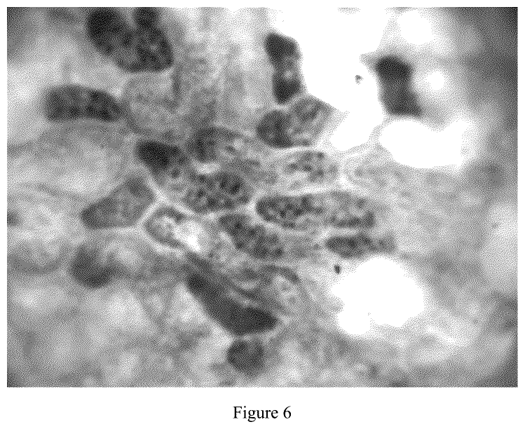

FIG. 6 shows the imaging results of double-staining with sodium fluorescein and crystal violet in pig kidneys. The contours of the liver cells and the morphology of the cell nuclei can be clearly seen after staining.

All references to the present disclosure are incorporated herein by reference in their entirety. It is further to be understood that, after reading the foregoing teachings of the present disclosure, various changes or modifications of the present disclosure may be made by those skilled in the art, and that such equivalent forms of modifications are likewise within the scope of the claims of the present disclosure.

1. A method for staining living cells for imaging, comprising:
simultaneously or separately, (i) staining target cells with sodium fluorescein; (ii) staining said target cells with methylene blue; and (iii) obtaining a fluorescence image of said target cell under a fluorescence microscope, wherein the sodium fluorescein has a concentration of 0.1% to 1%, and the methylene blue has a concentration of 0.5% to 3%.

2. The method according to claim 1, wherein the sodium fluorescein has a concentration of 0.25%, and the methylene blue has a concentration of 1%.

3. The method according to claim 1, wherein the method is for staining living tissues.

4. The method according to claim 1, wherein the living cells comprise cancer cells.

5. A composition for staining living cells, comprising a first fluorescent biomarker and a second fluorescent biomarker.

6. The composition according to claim 5, wherein the first fluorescent biomarker is sodium fluorescein, and the second fluorescent biomarker is methylene blue.

7. The composition according to claim 6, wherein the sodium fluorescein has a concentration of 0.1% to 1%, and the methylene blue has a concentration of 0.5% to 3%.

8. The composition according to claim 7, wherein the sodium fluorescein has a concentration of 0.25%, and the methylene blue has a concentration of 1%.

9. The composition according to claim 5, further comprising stabilizers, antioxidants, protectants, preservatives, and pH regulators.
